(19) United States
(12) Patent Application Publication
(10) Pub. No.: US 2026/0036147 A1
(43) Pub. Date: Feb. 5, 2026

(54) STACKED AIR-PULSE GENERATING DEVICE

(71) Applicant: xMEMS Labs, Inc., Santa Clara, CA (US)

(72) Inventor: Jemm Yue Liang, Sunnyvale, CA (US)

(73) Assignee: xMEMS Labs, Inc., Santa Clara, CA (US)

(21) Appl. No.: 19/287,798

(22) Filed: Jul. 31, 2025

Related U.S. Application Data
(60) Provisional application No. 63/678,658, filed on Aug. 2, 2024.

(51) Int. Cl. F04D 33/00; F04D 15/00; F04D 29/00

(52) U.S. Cl. CPC F04D 33/00; F04D 15/0005; F04D 29/002; F05D 2270/62

(57) ABSTRACT

A stacked-APG (APG: air-pulse generating) device includes a plurality of APG units stacked with each other. An APG unit comprises a membrane. The membrane is actuated to move in a membrane movement direction. The plurality of APG units is stacked in the membrane movement direction. The stacked-APG is capable of increasing airflow rate and persistent pressure.

### CROSS REFERENCE TO RELATED APPLICATIONS

This application claims the benefit of U.S. Provisional Application No. 63/678,658, filed on Aug. 2, 2024. The content of the application is incorporated herein by reference.

### BACKGROUND OF THE INVENTION

### 1. Field of the Invention

The present application relates to a stacked-APG (APG: air-pulse generating) device, and more particularly, to a stacked-APG capable of increasing airflow rate and persistent pressure.

### 2. Description of the Prior Art

Unless otherwise indicated herein, the approaches described in this section are not prior art to the claims in this application and are not admitted as prior art by inclusion in this section.

Air-pulse generating (APG) devices may be used in air movement. Previous APG devices may rely on Helmholtz resonators (HHRs) to enhance airflow. While HHRs could boost airflow, they present a peaking impedance at the pulse rate and were limited to a single application per device in practical use. This restricted the potential for significantly higher airflow gains.

Furthermore, a common challenge in forced air cooling applications is the presence of substantial pressure differences between the air outlet (facing the heat source) and the air inlet (facing the cool air source).

Such pressure differentials in prior art systems frequently led to a reduction in net airflow due to a “stealth vent” side-effect intrinsic to the “valve opens at the pulse rate” operation. Moreover, the persistent pressure generated by airflow in devices directly opposed the pressure gradient produced by membrane modulation movement, causing a rapid degradation of airflow generation capability and potentially ceasing airflow entirely when opposing pressures became equal.

These prior approaches lacked the capacity for achieving both significantly higher airflow rates and increased persistent pressure simultaneously, nor did they effectively mitigate the adverse effects of blowback airflow inherent in high-pressure differential scenarios.

Therefore, it is necessary to improve the prior art.

### SUMMARY OF THE INVENTION

It is therefore a primary objective of the present application to provide a stacked-APG capable of increasing airflow rate and persistent pressure, to improve over disadvantages of the prior art.

An embodiment of the present application provides a stacked-APG (APG: air-pulse generating) device. The stacked-APG device comprises a plurality of APG units stacked with each other. An APG unit comprises a membrane. The membrane is actuated to move in a membrane movement direction. The plurality of APG units is stacked in the membrane movement direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a first state of a stacked-APG device according to an embodiment of the present application.

FIG. 2 is a schematic diagram of a second state of the stacked-APG device according to an embodiment of the present application.

FIG. 3 is a schematic diagram of driving signals according to an embodiment of the present application.

FIG. 4 is a schematic diagram of a flap pair according to an embodiment of the present application.

### DETAILED DESCRIPTION

Content of U.S. Pat. No. 11,943,585, application Ser. No. 18/931,055 is incorporated herein by reference.

In U.S. Pat. No. 11,943,585, APG (air-pulse generating devices or air-pulse generator), comprising flap pair performing differential mode movement for demodulation and common mode movement for modulation and generating a plurality of air-pulses at ultrasonic pulse rate, capable of air moving efficiently, are introduced. In the present application, APG also refers to the flap pair structure (two flaps opposite to each other).

The present invention relates to using a multi-layer stacked-APG structure to increase both the rate of airflow generated and the persistent pressure created (stacked-APG).

In this invention, stacked-APG shall refer to devices comprising multiple layers of APG structure stacked in the direction of membrane movement, supported and separated by side walls, and operated in a choreographed or synchronized manner to achieve performance optimized across the stacked layers of APG structure.

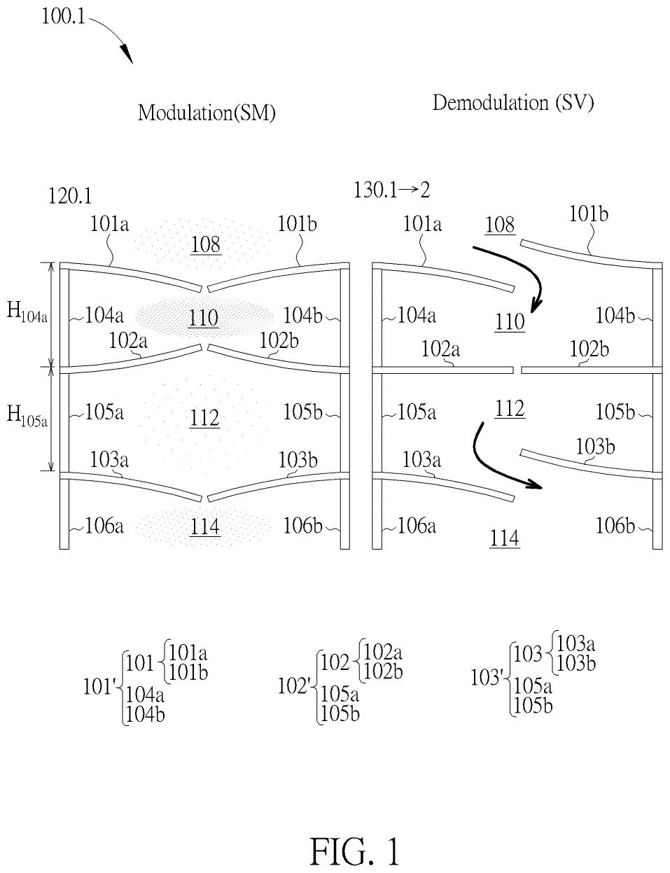

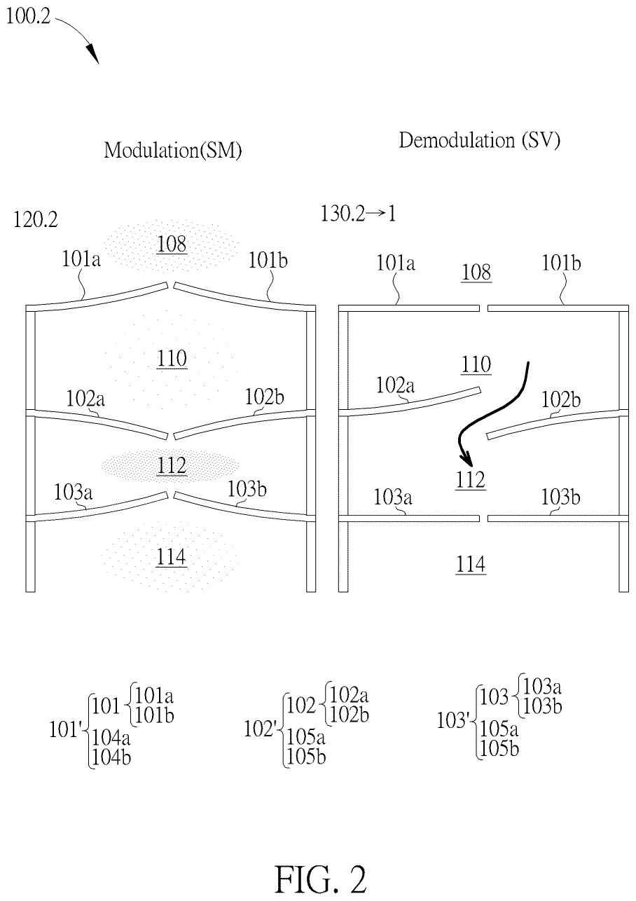

Referring to FIG. 1 and FIG. 2, the embodiment of device 100 comprises 3-layers of APG, represented by 3-pairs of opposing membranes or flaps 101a/b, 102a/b and 103a/b. These 3-layers of APG are stacked in an array fashion, with membrane-pairs facing one another, as illustrated in FIG. 1 and FIG. 2, where FIG. 1 illustrates an example of a 1st state of device 100 (100.1) and FIG. 2 illustrates an example of a 2nd state of device 100 (100.2).

In other words, the embodiment of device 100 comprises three flap pairs 101, 102 and 103. Each flap pair (e.g., 101, 102, or 103) comprises a first flap (e.g., 101a, 102a, or 103a) and a second flap (e.g., 101b, 102b, or 103b) opposite to each other. Moreover, sidewalls (e.g., 104a/b, 105a/b, or 106a/b) and flap pair (e.g., 101, 102, or 103) may form an APG unit (e.g., 101′, 102′, or 103′). That is, the stacked-APG device 100 may be viewed as comprising a plurality of APG units 101′, 102′, or 103′. Each APG unit (e.g., 101′, 102′, or 103′) comprises the flap pair (e.g., 101, 102, or 103). The flap pairs 101, 102, and 103 perform common mode movements (as shown in left portion of FIG. 1 and FIG. 2) driven by a modulation driving signal and perform differential mode movements (as shown in right portion of FIG. 1 and FIG. 2) driven by a demodulation driving signal.

During operation of device 100, states 100.1, 100.2, which may correspond to two states that are 180° out of phase from each other, and their intermediate states (not shown) loops/cycles at a pulse rate f_{Pulse}, where f_{Pulse} is usually much higher than human audible range, or 20 kHz. For example, device 100 may operate at a rate f_{Pulse} of 43 kHz with wavelength λ of 346/43=8.04 mm.

One aspect of the present invention is that multiple layers of APG device is not only physically stacked on top of one another, but also tightly coupled operationally to cause a synchronized choreography of air flow and pressure changes across the stacked-APG structure.

To achieve this tightly coupled operation, the max membrane-to-membrane spacing should be significantly less than one lump model limit λ/2π. In the case of device 100, this means spacing between membrane-pairs 101a/b and 103a/b<<8.04/2π≈1.28 mm. To satisfy this condition, the height of partition wall 104a/b, 105a/b (H_{104a/b}, H_{105a/b}) should be within 200˜500 μm. For example, assuming that H_{104a/b}=H_{105a/b}=320 μM≈λ/25, spacing between membrane-pairs 101a/b and 103a/b=H_{104a/b}+H_{105a/b}=640 μM≈λ/12.5, roughly half of λ/2π, ensuring tightly coupled operation across all layers of APG in device 100.

For ease of understanding and clarity of illustration, the displacements U_{Z} of the membrane is separated/decomposed into common mode (modulation) portion U_{Z_SM}, plots 120.1 and 120.2 on the left half and differential mode (demodulation) portion U_{Z_SV}, plots 130.1→2 and 130.2→2 on the right half. The actual displacement of membrane/flap 101a or 101b is the sum/aggregation of modulation displacement U_{Z_SM} and demodulation displacement U_{Z_SV}. Refer to U.S. Pat. No. 11,943,585 for more detailed discussion.

As FIG. 1 shown, in states 100.1, the common mode movement of the flap pair 101/103 is moving downward and the common mode movement of the flap pair 102 is moving upward. Corresponding to the states 100.1, virtual valves (will be explained later) formed by the flap pair 101/103 is opened and virtual valve formed by the flap pair 102 is closed.

On the other hand, as FIG. 2 shown, in states 100.2, the common mode movement of the flap pair 101/103 is moving upward and the common mode movement of the flap pair 102 is moving downward. Corresponding to the states 100.2, the virtual valves formed by the flap pair 101/103 is closed and the virtual valve formed by the flap pair 102 is opened.

Device 100 comprises 3 pairs of opposing flaps (101a, 101b), (102a, 102b), (103a, 103b). These opposing arranged membrane-pairs (or flap pairs), with a virtual valve (VV) defined by narrow slit of width of 0.5μ˜2 μm at the center of each membrane-pair.

These membrane-pairs and their surrounding/supporting side walls 104a/b, 105a/b, 106a/b, divide the space into 4 separate subspaces 108, 110, 112, and 114: subspace 110 between membrane pair 101a/b and 102a/b; subspace 112 between membrane pair 102a/b and 103a/b; subspace 108 above membrane pair 101a/b; subspace 114 below membrane pair 103a/b.

This invention further involves generating a modulation driving signal SM to cause “modulation” of two states, such as the example illustrated in 120.1 of FIG. 1 and 120.2 of FIG. 2, to cause chamber 110 and chamber 112 to go through a synchronized compress-expand cycles that is roughly 180° out of phase. Note the illustration in FIG. 1 and FIG. 2 show just one example of possible states and the invention is not limited thereto.

This invention further involves generating a demodulation driving signal SV, and SV is choreographed or timed in such a way as to create synchronize “demodulation” action of the stacked-APG layers. For example, state transition 130.1→2 illustrated in FIG. 1 will cause air to be sucked from subspace 108 into subspace 110 and to be pushed from subspace 112 out to subspace 114; while state transition 130.2→1 illustrated in FIG. 2 will cause air to be pushed/pulled from subspace 110 into subspace 112.

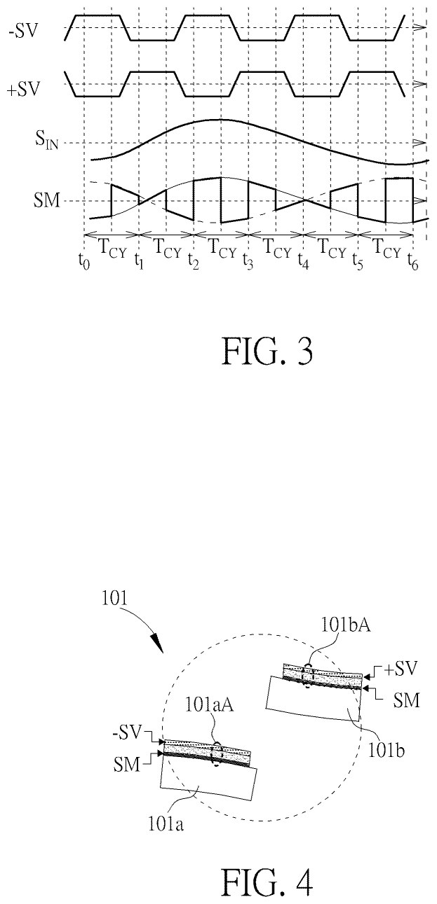

Waveforms of the modulation driving signal SM and the demodulation driving signal SV are similar to which is shown in FIG. 3, excerpted from U.S. Pat. No. 11,943,585, as an example. Phase between the signals SM and SV may be further optimized, according to practical requirements. In addition, take the flap pair 101 as an example, as shown in FIG. 4 (also excerpted from U.S. Pat. No. 11,943,585), the flap pair 101 comprises actuators 101aA and 101bA, disposed on the flaps 101a and 101b, respectively. Each actuator comprises two electrodes. One electrode receives the demodulation driving signal SV and the other receives the modulation driving signal SM.

In other words, left portions of FIG. 1 and FIG. 2 illustrate common mode movements of the flap pairs 101, 102, 103, driven by the modulation driving signal SM, and right portions of FIG. 1 and FIG. 2 illustrate differential mode movements of the flap pairs 101, 102, 103, driven by the demodulation driving signal SV.

As illustrated in FIG. 2, VV formed by membrane-pairs 101a/b and 103a/b may be in their “closed” state during state transition 130.2→1, meaning pressures in subspaces 108 and 114 may be largely blocked/isolated from subspaces 110 and 112, leaving the air movement between subspaces 110 and 112 largely unaffected by the pressures in subspaces 108 and 114.

Note that the air movement discussed above is just one example of demodulation timing control. The direction of air flow can be altered by changing the timing (especially the phase) of the demodulation signal SV.

Further note that, in addition to phase, the amplitude of demodulation driving signal SV also plays a critical role: determining the duty factor of “valve opened” state versus “valve closed” state. The virtual valve VV “opened” state and “closed” state can be defined by the relationship between ΔU_{Z_SV} (displacement difference of the two flaps driven by signal SV) and the thickness of membrane H_{VV}: a) when ΔU_{Z_SV}>H_{VV}, VV is said to be “Opened”; b) when H_{VV}>ΔU_{Z_SV}, VV is said to be “Closed”.

Therefore, the % of time VV is “opened”, i.e. duty factor of “opened” state or DF_{Open}, will increase when amplitude of SV increases, and DF_{Open} will decrease when amplitude of SV decreases.

In the present invention, the DF_{Open} of each of the stacked-APG layer, chosen for optimized performance of the entire stacked-APG device 100, may be controlled by adjust the amplitude of its specific SV.

As a rule of thumb, when the magnitude of persistent pressure, |ΔP|, across a given membrane-pair is low (e.g. <10 Pa), the optimal DF_{Open} may be >>50% (DF_{Open} may fall between 63˜82% depends on factors such as the pulse-rate and the design of APG, such as the presence or absence of tooth-edge introduced in U.S. Pat. No. 12,317,034, etc.) As the across-membrane persistent-pressure rises, the optimal DF_{Open} will typically lower gradually toward 50% and may even go below 50% when |ΔP|>>1 kPa. The most direct reason for the trend mentioned above is because the speed of block-back airflow rises proportional to |ΔP| due to the “stealth vent” effect intrinsic to the VV open-close of APG device. Since the net airflow generated by an APG device needs to deduct the block-back airflow, the optimal DF_{Open} will shift from >>50% toward <50% as |ΔP| rises.

In the present application, the term “persistent pressure” refers to the pressure built-up gradually over continuous operation of the device. This is the “DC” or “steady” portion of the total pressure. The total generated pressure also contains an “AC” or “high frequency” portion, which is created by the movements of and interactions between membranes 101a/b, 102a/b, 103a/b.

For example, if the application of the embodiment 100 in FIG. 1 and FIG. 2 is a “push” or “blow” operation and require high positive persistent pressure on side facing space volume 114 (which may be the internal space within a mobile processor heat management apparatus), i.e. P₁₁₄>>P₁₀₈ where P₁₀₈ maybe ambient ˜1 ATM, then the DF_{Open} of membrane-pair 103a/b may be lowered to strengthen its blocking/isolating effect and reduce the speed of air flowing through membrane-pair 103a/b due to “stealth vent” effect, while membrane-pair 101a/b may have a DF_{Open} near the max value to maximize airflow generation by 101a/b.

On the other hand, if the application of the embodiment 100 in FIG. 1 and FIG. 2 is a “pull” or “suck” operation and require high negative persistent pressure on the side facing space volume 108 (which may be the internal space within a mobile processor heat management apparatus), i.e. P₁₀₈<<P₁₁₄ where P₁₁₄ maybe ambient ˜1 ATM, then the DF_{Open} of membrane-pair 101a/b may be lowered to strengthen its blocking/isolating effect and reduce the speed of air flowing through membrane-pair 101a/b due to “stealth vent” effect, while membrane-pair 103a/b may have a DF_{Open} near the max value to maximize airflow generation by 103a/b.

Both above examples referenced an “internal space within a mobile processor heat management apparatus”. Determining which operation mode (“push/blow” mode or “pull/suck” mode) is proper is important. Since compressing air increase air's temperature, the “push/blow” operation mode will raise the temperature of ambient air before pushing it into the heat management apparatus, therefore, device 100 operates in “push/blow” mode may have low heat removal efficiency than the one operates in “pull/suck” mode.

Note that two pairs of push-pull relationships are formed: one between membrane pair 101a/b and membrane pair 102a/b; one between membrane pair 102a/b and membrane pair 103a/b.

When the operation of these membrane pairs are properly timed, such as illustrated in FIG. 1 and FIG. 2, a double push-pull arrangement will be created, and such double push-pull will magnify the ΔP across slits when membrane pair 102a/b is in the “opened” state, resulting in stronger airflow flowing through the “opened” virtual valve defined by membrane pair 102a/b.

In a typical embodiment in U.S. Pat. No. 11,943,585 and Ser. No. 18/931,055, Helmholtz resonators (HHR) tuned to f_{Pulse} are usually applied via lid side embodiment or via LGA side embodiment. By presenting a peaking impendence Z at f_{Pulse}, such HHR can boost the airflow by 3˜5× (9.5˜14 dB) compared to capless (plain, bare) MEMS part.

In this invention such HHR is supplanted by explicit VV open-close operation of neighboring membrane-pair(s). For example, membrane-pair 101a/b maybe timed to be “closed”, reaching maximum impedance, at the optimal timing relative to operation of membrane-pair 102a/b; and 102a/b maybe timed to be “closed”, reaching maximum impedance, at the optimal timing relative to operation of membrane-pair 103a/b; and vice versa.

Note that since the VV close-open can produce a much higher Z_{Max}/Z_{Min} ratio than HHR, the airflow boosting of the stacked-APG device 100 can also be much higher relative to capless (plain, bare) MEMS device, than HHR based APG device.

Since, in practical application, it is found only one HHR may be applied to U.S. Pat. No. 11,943,585 device, therefore the above analyses-comparisons are only applicable to 2-layer stacked-APG device.

However, for the 3-layer stacked-APG device 100, the airflow boosting by the high Z_{Max}/Z_{Min} ratio of VV close-open states will be applied to both sides of the center layer.

In addition to high Z_{Max}/Z_{Min} ratio of VV close-open (factor 1), the addition APG layer which produce addition U_{Z_SM} increasing/doubling the pressure difference across membrane-pair 102a/b (factor 2), while staying “closed” to minimize the counterproductive block-back airflow (factor 3). Combining these 3 factors, it means the 3-layer stacked-APG device 100 character, when its operation is optimally choreographed across all 3 stacked-layers of APG, may produce an airflow boosting ratio that is much higher than 5 times, relative to capless (plain, bare) MEMS device.

In forced air cooling, it is typical for the air outlet side (facing heat source) to have significantly higher pressure than the air inlet side (facing source of cool air). Such high pressure-difference can cause net airflow to drop due to the “stealth vent” side-effect of intrinsic to the “valve opens at the pulse rate” of APG operation.

In the present invention, by arranging at least one pair of membrane to be in the “closed” state while other membrane pairs are in the “opened” state, the blowback airflow due to “stealth vent” effect can be minimized, and thus lead to increased net airflow.

In comparison to Z created by HHR of prior single layer embodiment of U.S. Pat. No. 11,943,585, the time-varying Z due to the open-close operation of neighboring membrane-pair(s) of the present invention, when well synchronized, can produce far higher ΔP, because the membrane-pair movements of all three stacked-APG (e.g. device 100) are under consideration now.

Take membrane-pair 102a/b as example, in state plot 120.2, volume 110 is (double) expanded by having membrane-pairs 102a/b and 101a/b moving away each other, while volume 120 is (double) compressed by having membrane-pairs 102a/b and 103a/b moving toward each other. The combined effect of the membrane motions described above and the much higher Z_{Open}/Z_{Close} ratio discussed in prior section creates a “membrane movement induced ΔP” that is far higher than possible in the HHR loaded embodiment.

In addition to much higher “membrane movement induced ΔP”, the persistent ΔP due to the airflow (which will point from volume 114→112→110 in the example illustrated in FIG. 1 and FIG. 2) may be blocked/isolated, as illustrated in 130.2→1 of FIG. 2, by closing membrane-pair 103a/b when generating airflow through “valve opened” state of membrane-pair 102a/b.

Since such blocking/isolation action of membrane-pair 103a/b insulates space volumes 110, 112 from the influence of pressure in space volume 114, it allows persistent ΔP (in space volume 114) to rise much higher compared to single layer embodiment.

Another effect of the above block/isolate by arranging the membrane-pair facing the high |ΔP| to be in the “closed” state is it also minimizes blow-back airflow due to the “stealth vent” effect. This means net airflow will increase significantly, which will increase the |ΔP| for any given impedance Z to the airflow.

Due to avoidance of HHR, the need for HHR chamber is also obliviated. In other words, stacked-APG device 100 can be attached directly to a heat management apparatus, e.g., walls 106a/b may attach to a mobile processor directly, possibly even by silicon-silicon bounding.

Although 3-layer stacked-APG is shown in FIG. 1 and FIG. 2, similar arrangements can be made using 2-layer, 4-layer, or 5-layer stack. All such variations are within the scope of this invention.

The phase relationships between the three modulation displacements and their respective relationship to demodulation displacements are for illustrations only. Although the shown relationship is generally correct but the actual implementation will need to be tuned based on actual design geometry details and the intended airflow volume, pressure of the specific instance of Sequoia implementation/application.

The amplitudes of membrane displacements, both in modulation and demodulation, may be different at each stack layer. The precise amplitude at each layer should be optimized according to the application, such as the anticipated ΔP, the desired airflow (cc/sec), etc. By using tools such as finite element simulation, different arrangements may be experimented virtually and the optimal combination can be selected.

As can be seen from the above, an advantage of the present invention lies in its ability to significantly increase both airflow rate and persistent pressure, while effectively overcoming the limitations and drawbacks present in prior art. This is achieved primarily through much higher airflow boosting, where the explicit open-close operation of virtual valves (VV) in neighboring membrane-pair(s) can produce a significantly higher impedance ratio (Z_{Max}/Z_{Min}) compared to conventional Helmholtz resonators (HHRs). For the 3-layer stacked-APG device, this airflow boosting can be much higher than 5 times relative to capless (plain, bare) MEMS devices.

Furthermore, the synchronized and choreographed membrane movements across multiple stacked layers, combined with the higher Z_{Open}/Z_{Close} ratio, create a “membrane movement induced ΔP” that is far higher than possible in HHR-loaded embodiments of previous APG devices. The present invention also enables effective blowback prevention and pressure isolation by strategically “closing” certain membrane pairs to block or isolate high-pressure areas, which significantly minimizes blow-back airflow due to the “stealth vent” effect and allows persistent ΔP to rise much higher compared to single-layer APG devices.

Additionally, the device offers optimized heat dissipation efficiency; recognizing that compressing air increases its temperature, the “pull/suck” operation mode provides superior heat removal efficiency in applications such as mobile processor heat management, as it avoids pre-heating ambient air before it enters the apparatus.

Lastly, the elimination of HHRs obviates the need for an HHR chamber, allowing for direct mounting of the stacked-APG device to a heat management apparatus, potentially through silicon-silicon bonding.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A stacked-APG (APG: air-pulse generating) device, comprising:
a plurality of APG units stacked with each other;
wherein an APG unit comprises a membrane, the membrane is actuated to move in a membrane movement direction;
wherein the plurality of APG units is stacked in the membrane movement direction.

2. The stacked-APG device of claim 1,
wherein the plurality of APG units comprises a plurality of flap pairs;
wherein plurality of flap pairs performs common mode movements.

3. The stacked-APG device of claim 1,
wherein the plurality of APG units comprises a first APG unit and a second APG unit;
wherein the first APG unit is directly stacked on the second APG unit;
wherein the first APG unit comprises a first flap pair and the second APG unit comprises a second flap pair;
wherein the first flap pair performs a first common mode movement and the second flap pair performs a second common mode movement;
wherein the first common mode movement is opposite to the second common mode movement.

4. The stacked-APG device of claim 3,
wherein when the first flap pair moves toward a first direction as the first common mode movement, the second flap pair moves toward a second direction opposite to the first direction as the second common mode movement.

5. The stacked-APG device of claim 4,
wherein the plurality of APG units comprises a third APG unit;
wherein the second APG unit is directly stacked on the third APG unit;
wherein the third APG unit comprises a third flap pair;
wherein the third flap pair performs a third common mode movement.

6. The stacked-APG device of claim 5,
wherein when the first flap pair moves toward a first direction as the first common mode movement, the third flap pair moves toward the first direction as the third common mode movement.

7. The stacked-APG device of claim 1,
wherein the plurality of APG units comprises a plurality of flap pairs;
wherein plurality of flap pairs performs differential mode movements.

8. The stacked-APG device of claim 1,
wherein the plurality of APG units comprises a first APG unit and a second APG unit;
wherein the first APG unit is directly stacked on the second APG unit;
wherein the first APG unit comprises a first flap pair and the second APG unit comprises a second flap pair;
wherein the first flap pair performs a first differential mode movement and the second flap pair performs a second differential mode movement.

9. The stacked-APG device of claim 8,
wherein the first flap pair performs the first differential mode movement to form a first virtual valve;
wherein the second flap pair performs the second differential mode movement to form a second virtual valve.

10. The stacked-APG device of claim 9,
wherein when the first virtual valve is closed, the second virtual valve is opened.

11. The stacked-APG device of claim 9,
wherein when the first virtual valve is opened, the second virtual valve is closed.

12. The stacked-APG device of claim 9,
wherein the plurality of APG units comprises a third APG unit;
wherein the second APG unit is directly stacked on the third APG unit;
wherein the third APG unit comprises a third flap pair;
wherein the third flap pair performs a third differential mode movement to form a third virtual valve.

13. The stacked-APG device of claim 12,
wherein when the first virtual valve is closed, the second virtual valve is opened and the third virtual valve is closed.

14. The stacked-APG device of claim 12,
wherein when the first virtual valve is opened, the second virtual valve is closed and the third virtual valve is opened.

15. The stacked-APG device of claim 1,
wherein the stacked-APG device is driven by a modulation driving signal to perform a common mode movement.

16. The stacked-APG device of claim 1,
wherein the stacked-APG device is driven by a demodulation driving signal to perform a differential mode movement.

17. The stacked-APG device of claim 1, comprising:
an actuator, comprising a first electrode and a second electrode;
wherein the first electrode and the second electrode receive a modulation driving signal and demodulation driving signal.

18. The stacked-APG device of claim 1,
wherein a maximum membrane-to-membrane spacing is less than λ/2π;
wherein λ is a wavelength corresponding to a pulse rate of the stacked-APG device.
